(19) United States
(12) Patent Application Publication
(10) Pub. No.: US 2005/0181003 A1
(43) Pub. Date: Aug. 18, 2005

(54) Rodenticidal bait systems

(76) Inventors: Stefan Endepols, Burscheid (DE); Thomas Bocker, Leichlingen (DE)

Correspondence Address: BAYER CROPSCIENCE LP;Patent Department, 100 BAYER ROAD, PITTSBURGH, PA, 15205-9741, US

(21) Appl. No.: 10/513,525

(22) PCT Filed: Apr. 24, 2003
(86) PCT No.: PCT/EP03/04250

(30) Foreign Application Priority Data
May 7, 2002 (DE) 102 20 271.0

(51) Int. Cl. A01N 25/08

(52) U.S. Cl. 424/410

(57) ABSTRACT

The present invention relates to water-based rodenticidal gels which do not cure, remain attractive to harmful rodents for long period, retain their viscosity and adhere permanently to surfaces.

The present invention relates to water-based rodenticidal gels which do not cure, remain attractive to harmful rodents for long periods, retain their viscosity and adhere permanently to surfaces.

As a rule, harmful rodents are controlled using rodenticide-containing feed baits. Conventional baits are made from loose cereals and a liquid or pulverulent premix containing the active ingredient. The product is a flowable cereal bait. If the mixture is treated with liquid paraffin and extruded, pellets or granules can be produced. The advantage of these variants over the flowable baits is the homogeneous distribution of the active ingredient. Wax bars are likewise produced from a paraffin-containing premix. This premix is extruded or poured into bars 10 g-100 g in weight. Bars are easily handled, but, as a rule, not very attractive to rodents owing to the high paraffin content. A modern development which combines the ease of handling of the wax bars with high attraction to rodents is the rodenticidal bait paste. Rodenticidal pastes are based on ground cereals and vegetable oils. Pastes are usually packaged in paper sachets in 10 g-100 g portions. Low-viscosity pasty baits may also be packaged in cartridges.

Flowable baits must be applied in containers such as dishes or bait boxes. Wax bars and paste sachets are placed in covered locations in such a way that they are protected from the effects of the weather. In animal houses, baits must be applied in such a way that they remain unaffected by cleaning and disinfection work. In general, the user of baits must ensure that anybody who is unauthorized such as, for example, children and non-target animals, such as, for example, domestic animals, cannot access the bait.

Harmful rodents, in particular rats and mice, frequently attack properties where foodstuffs or feeding stuffs are being stored. Since they are capable of transmitting and excreting a number of pathogens, harmful rodents are controlled intensively in these susceptible spaces. Hygiene programmes generally demand regular, prophylactic control and monitoring. The control measures must meet two essential criteria: 1.) The bait used must be sufficiently attractive to the harmful rodents that they ingest it even in the presence of an excess of high-quality feed alternatives, and 2.) These rodenticides must be applied in such a way that they must not come into contact with the stored products or non-target animals.

Pastes and flowable baits are preferably used owing to their good palatability. These baits are applied in specific bait containers to minimize any chances of contaminating the stored goods and to prevent non-target animals from reaching the compositions. Wax bars and pasty baits are additionally secured by tying.

As a rule, bait boxes must be used to ensure safe application. These bait boxes are normally placed on the ground so that no bait can reach the stored products when rats or mice scratch in the bait containers.

The disadvantage of this application technique is that the bait containers can frequently not be positioned where rats and mice prefer to dwell. These animals frequently nest in cavities of walls and ceilings, from where they can reach the stored products without running on the ground, for example via pipes, shelves and dividing walls. In this case, the control measures would be effective if a bait which is palatable to rats and mice and which cannot be spilt or carried away would be attached above or next to the stored products which serve as food supply to the harmful rodents. This bait must be attractive and contain high-quality food or feed in order to be accepted by the rodents as an alternative food source. If such a bait were applied without bait box, it would additionally be ensured that the control measures are not encumbered by the animals' fear of these containers.

A bait which meets these requirements is unknown. While pasty baits which are based on oils and fats and which can be applied for example by squeezing a cartridge and initially adhere to the surface (for example JP 60255701) have been developed, these pastes frequently have the disadvantage that oil leaks from the cartridge when pressure is exerted, i.e. upon use, which makes neat handling impossible. Moreover, the oil spreads on the treated surface and the baits turn rancid and thus become unattractive and ineffective. They cure and then no longer adhere to the surface. Resulting particles may contaminate foodstuffs and feeding stuffs.

Non fatty formulations are likewise known. However, they do not contain energy-containing feeding stuffs and are therefore not baits (for example WO 2001/080645), but concentrates or stickers (for example WO 98/04129, RU 2077200, DD 271012), have a shelf life of only a few days (for example Veterinariy 1990, No. 2, 29-30), are only suitable for controlling moles (for example U.S. Pat. No. 6,264,969, FR 2767464), are intermediates in bait production, but are not ready for use (for example EP 97093, U.S. Pat. No. 4,480,089). Such mixtures frequently contain a number of chemicals which make the product useless for use in baits, owing to the repellent odour (for example JP 51033964). It is known that such concentrates are produced on the basis of polyethylene glycol (PEG); for example JP 48001121. However, PEG is not eaten by rodents, but is only suitable as carrier in what are known as stickers. Upon contact, they stick to the animals' coat, but the animals only ingest the active ingredient when they clean their coats (see also JP 44012440). Other agents which ingested by rodents under certain circumstances, while being, are based, inter alia, on pectin or agar agar and therefore deteriorate rapidly and are therefore not suitable as baits (for example EP 2129376). Also known are water-in-oil dispersions (WO 2002/010212), hydrophobic, waxy formulas (FR 2067818) and gels which are provided with acute poisons, contain no feedstuffs but only flavourings and are applied in specifically developed containers for controlling exotic pests (EP 1094705).

The invention aims at providing a bait system without the abovementioned disadvantages.

The present invention relates to a new bait system consisting of a water-based rodenticidal gel which remains attractive to harmful rodents over a long period, does not cure, retains its viscosity and adheres permanently to surfaces. These gels according to the invention are applied without packaging or specially developed containers and are packaged ready for use. They can be applied safely and without bait boxes.

The gels according to the invention are dimensionally stable, readily deformable disperse-systems encompassing the following components:
(a) water as dispersant;
(b) thickener;
(c) active compound(s);
(d) bait materials;
(e) preservative.

In a preferred embodiment, the gels according to the invention additionally encompass one or more of the following components:
(f) base;
(g) humectant;
(h) antioxidants;
(i) colours;
(j) bittering agents;
(k) additives.

Organic and inorganic macromolecules are used by way of thickeners. Organic macromolecules which may be mentioned are cellulose derivatives, for example hydroxypropolycellulose, hydroxyethylcellulose, methylcellulose, carboxymethyl-cellulose sodium, hydroxypropylmethylcellulose, hydroxyethylmethylcellulose, hydroxyethylpropylcellulose and xanthans, alginates, carrageenan, agar-agar, polyvinyl alcohols, polyvinylpyrrolidone, polyacrylic acid and polymethacrylic acid.

Inorganic macromolecules (inorganic gellants) which may be mentioned are highly disperse silica and bentonites (for example Rudolf Voigt, Pharmazeutische Technologie, Pages 362-385, Ulstein Mosby).

The following are preferred: methylcellulose, hydroxyethylcellulose, carboxylmethylcellulose-sodium, hydroxypropylcellulose, xanthans, polyacrylic acid and polymethacrylic acid.

The following are especially preferred: methylcellulose, hydroxyethylcellulose, carboxymethylcellulose-sodium and polyacrylic acid.

Suitable active compounds are stomach poisons, preferably anticoagulants from the group of the indanedione derivatives or of the hydroxycoumarins, 1^{st} and 2^{nd} generation. These substances are used all over the world for controlling rodents (cf., for example, DE 2506769; JP 48023942; CH 481580; Tammes et al. (1967): Acta Physiol. Pharmacol. 14 p. 423433; Paposci (1974) Beihefte Z. Angew. Zool. p. 155 and DE 2 506 769). Examples of anticoagulants are the 4-hydroxycoumarin derivatives (1-phenyl-2-acetyl)-3-ethyl-4-hydroxycoumarin (“warfarin”), 3-(α-acetonyl-4-chlorobenzyl)-4-hydroxycoumarin (“coumachlor”), [3-(4′-hydroxy-3′-coumarinyl)-3-phenyl-1-(4′-bromo-4′-biphenyl)-propan-1-ol (“bromadiolon”), 3-(3′-paradiphenylyl-1′,2′,3′,4′-tetrahydro-1′-naphthyl)-4-hydroxycoumarin (“difenacoum”) brodifacoum, flocoumafen and 3-(1′,2′,3′,4′-tetrahydro-1′-naphthyl)-4-hydroxycoumarin (“coumatetralyl”), the indanedione derivatives such as 1,1-diphenyl-2-acetylindane-1,3-dione (“diphacinone”) and (1′-p-chlorophenyl-1′-phenyl)-2-acetylindane-1,3-dione (“chlorodiphacinone”) and the hydroxy-4-benzothiopyranones, for example (“difethialone”). Further anticoagulants which are suitable for preparing the bait according to the invention and which may be mentioned are the following 2-azacycloalkylmethyl-substituted benzhydryl ketones and benzhydrylcarbinols: 1-phenyl-3-(2-piperidyl)-1-(p-tolyl)-2-propanone, 3,3-diphenyl-1-(2-pyrrolidinyl)-2-pentanone, 1,1-diphenyl-3-[2-(hexahydro-1H-azepinyl)]-2-propanone, 1-(4-fluorophenyl)-1-phenyl-3-(2-piperidyl)-2-propanone, 1-(4-methylthiophenyl)-1-phenyl-3-(5,5-dimethyl-2-pyrrolidinyl)-2-propanone, 1-(p-cumenyl)-1-phenyl-3-(tert-butyl-2-piperidinyl)-2-propanone, 3,3-diphenyl-1-[2-(hexahydro-1H-azepinyl]-2-butanone, 3-(2,4-dichlorophenyl)-3-phenyl-1-(2-piperidyl)-2-heptanone, 1,1-diphenyl-3-(5-methyl-2-pyrrolidinyl)-2-propanone, 3,3-diphenyl-1-(2-piperidyl)-2-butanone, α-(α-methyl-α-phenylbenzyl)-2-piperidinethanol, α-(α-ethyl-α-phenylbenzyl)-2-pyrrolidinethanol, (2,5-dimethyl-α-phenylbenzyl)-2-piperidinethanol and α-(diphenylmethyl)-2-(hexahydro-1H-azepin)ethanol and their salts, which are described in DT-OS 2 417 783, and 4′-(fluorophenyl)-2-(2-pyrrolidinyl)-acetophenone, 4′-phenyl-2-(5,5-dimethyl-2-pyrrolidinyl)-acetophenone, 4′-[p-(trifluoromethyl)-phenyl]-2-(2-piperidyl)-acetophenone, 4′-(p-butoxyphenyl)-2-(4-tert-butyl-2-piperidyl)-acetophenone, 2′-phenoxy-2-(2-piperidyl)-acetophenone, 4′-(p-fluorophenoxy)-2-(5,5-dimethyl-2-pyrrolidinyl)-acetophenone, 4′-(p-chlorophenoxy)-2-(2-piperidyl)-acetophenone, 4′-[m-(trifluoromethyl)-phenoxy]-2-(2-piperidyl)-acetophenone, 4′-(p-butoxyphenoxy)-2-(2-pyrrolidinyl)-acetophenone, 2-(2-piperidyl)-4′-(trans-p-tolylvinylene)-acetophenone, 2-(2-hexahydro-1H-azepinyl)-4′-(trans-styryl)-acetophenone, 4′-(m-methoxyphenylvinylene)-2-(2-pyrrolidinyl)-acetophenone, 2-(2-piperidyl)-4′-[(p-methylthio)-phenylvinylene]-acetophenone, 4′-(3-phenoxypropoxy)-2-(2-piperidyl)-acetophenone, 4′-(4-phenylbutyl)-2-(2-piperidyl)-acetophenone, 4′-(α,α-dimethylbenzyl)-2-(piperidyl)-acetophenone, 4′-phenethyl-2-(3,5-diethyl-2-piperidyl)-acetophenone, 4′-phenyl-2-(2-pyrrolidinyl)-acetophenone, α-[2-(2-phenylethoxy)phenyl]-2-piperidinethanol, α-(p-phenoxyphenyl)-2-pyrrolidinethanol, α-[4-(4-bromophenoxy)-phenyl]-6-methyl-2-piperidinethanol, α-(p-phenethyl)-phenyl-2-pyrrolidinethanol, α-p-bisphenyl-2-hexanehydro-1H-azepinethanol, α-[3-(4-phenoxybutoxy)-phenyl]-2-piperidinethanol and α-(4-benzyl)-phenyl-2-piperidinethanol and their salts (cf. DE-A-2 418 480). The following rare-earth metal salts may also be used as anticoagulant: dineodymium dihydroxybenzenedisulphonate (Acta physiol. Acad. Sci. Hungar. 24, 373), dineodymium 3-sulphonatopyridine-4-carboxylate and cerium(III) tris-(4-aminobenzenesulphonate). Moreover, any other rodenticidal active ingredient may be used in the above-described system, such as acutely acting rodenticides, for example alpha-chloralose, alpha-naphthylthiourea, N-methyl-2,4-dinitro-N(2,4,6-tribromophenyl)-6-(trifluoromethyl)benzamine (“bromethalin”), Vitamin D2 and D3 (calciferol, cholecalciferol), (2-chloro-4-dimethylamino-6-methylpyrimidine (“crimidine”), O,O-bis(p-chlorophenyl)acetimidoyl phosphoramidothioate, sodium monofluoroacetate, N-3-pyridylmethyl N′-p-nitrophenylurea (“pyriminyl”), 3,4,5,-trimethoxybenzoyl methylreserpate (“reserpine”), thallium sulphate, zinc phosphide.

Substances which are preferably used as active compound are hydroxycoumarins indanedione derivatives and calciferols (Vitamin D2 and D3) and combinations of an anticoagulant with a calciferol.

Substances which are especially preferred as active compound are 2^{nd} generation hydroxycoumarins, such as, for example, difethialone, and calciferol and cholecaliferol.

The gels according to the invention contain one or more of the abovementioned active compounds.

In a preferred embodiment, the gels according to the invention contain one of the abovementioned active compounds.

Vegetable or animal foodstuffs and feeding stuffs are mentioned by way of bait materials. Examples of suitable materials are coarse and fine cereal meals or flaked cereals (for example oats, wheat, barley, maize, soya, rice), ground coconut, ground coconut, sugar syrups (for example obtained by hydrolysing starch (glucose syrup), invert syrup, beet sugar syrup, maple syrup), sugars (for example sucrose, lactose, fructose, glucose), grated nuts, ground nuts (for example hazelnuts, walnuts, almonds), vegetable fats/oils (for example rapeseed oil, soya fat, sunflower oil, cacao butter, peanut oil, peanut butter, corn oil), animal fats/oils (butter, lard, fish oil), proteins (for example dry skimmed milk, powdered egg, protein digests).

Substances which are preferred are vegetable foodstuffs such as, for example, coarse oatmeal, wheat flour, maize meal, flaked coconut, ground coconuts, glucose syrup, maple syrup, beet sugar syrup, sucrose, glucose, ground hazelnuts, ground walnuts, almonds, rapeseed oil, soya fat, peanut oil, corn oil; animal fats such as, for example, butter; proteins such as, for example, powdered egg and dry skimmed milk.

The following substances are especially preferred: vegetable foodstuffs such as, for example, coarse oatmeal, maize meal, flaked coconut, ground coconut, glucose syrup, maple syrup, sucrose, ground hazelnuts, soya fat, peanut oil, peanut butter and proteins such as, for example, dry skimmed milk.

Vegetable foodstuffs are very especially preferred.

The gels according to the invention may comprise one or more of the abovementioned bait materials.

It is preferred to employ two different bait materials in the gels according to the invention.

Materials which are mentioned by way of preservatives are, for example, parabens (methyl-4-hydroxybenzoate, propyl-4-hydroxybenzoate), benzoic acid and its salts (for example sodium benzoate), sorbic acid and its salts (for example potassium sorbate), propionic acid and its salts (for example sodium propionate), ethanol, benzyl alcohol, cresol, chlorocresol, mixtures of chloromethylisothiazolinone/methylisothiazolinone, 2-bromo-2-nitropropane-1,3-diol and 1,2-benzoisothiazol-3(2H)-one. Preservatives may be added to prevent the development of mould.

Substances which are preferred are parabens (methyl-4-hydroxybenzoate, propyl-4-hydroxybenzoate), sorbic acid and its salts (for example potassium sorbate), propionic acid and its salts (for example sodium propionate), ethanols, mixtures of chloromethylisothiazolinone/methylisothiazolinone, 2-bromo-2-nitropropane-1,3-diol and 1,2-benzoisothiazol-3(2H)-one.

Mixtures of chloromethylisothiazolinone/methylisothiazolinone, 2-bromo-2-nitropropane-1,3-diol and 1,2-benzoisothiazol-3(2H)-one are especially preferred.

Substances which are mentioned by way of bases are. for example, alkali metal hydroxides, alkaline earth metal hydroxides and amino derivatives such as potassium hydroxide, sodium hydroxide, triethanolamine or ammonium hydroxide solution. Bases may be used for adjusting the pH.

Substances which are mentioned by way of humectants are, for example polyols such as glycerol, propylene glycol, ethylene glycol, sugar alcohols and polypropylene glycols. Humectants prevent drying out of the gel so that it remains elastic and is not scattered when ingested by the rodents.

Substances which are preferred are glycerol, propylene glycol, polypropylene glycol 200, propylene glycol 300, polypropylene glycol 400, sorbitol, mannitol and xylitol.

Substances which are especially preferred are glycerol, propylene glycol, polypropylene glycol 200, propylene glycol 300 and sorbitol. Substances which are mentioned by way of antioxidants are butylhydroxytoluene, butylhydroxyanisol, tocopherols (for example Vitamin E) or ascorbic acid and its derivatives (for example ascorbic acid palmitate, sodium ascorbate). The foodstuffs or feeding stuffs may be stabilized by adding antioxidants.

Substances which are preferred are butylhydroxytoluene, vitamin E, ascorbic acid palmitate and ascorbic acid.

Substances which are especially preferred are butylhydroxytoluene, Vitamin E and ascorbic acid.

Substances which are mentioned by way of colours are blue, green and red pigments and blue, green and red colorants (see Colour Index, Fourth Edition: Hue blue, red, green). The gel according to the invention may be stained by colours by way of warning.

Substances which are preferred are suitable colours which are also approved for colouring cosmetics (cf., for example, Otterstätter, Die Färbung von Lebensmitteln, Arzneimitteln, Kosmetika [Colouring foodstuffs, pharmaceuticals and cosmetics], Behr's Verlag, 2^{nd} edition, p. 52-57).

Pigments are preferably used.

Substances which can be used by way of additives are, for example, bittering agents such as denatonium benzoate and natural and synthetic aromas (see the product list of Hamann & Reimer, Holzminden).

The gels according to the invention comprise (in percent by weight)
0.3-15% of thickeners;
0.0005-1.0% of active compound;
10-80% of bait materials;
0.01-2% of preservatives;
optionally 0.5-8% of base;
optionally 3-25% of humectants;
optionally 0.01-2% of antioxidants;
optionally 0.001-0.2% of colours;
optionally 0.001-0.02% of additives
and water as the remainder (in percent by weight).

Preferably, the gels according to the invention comprise (in percent by weight)
0.4-10% of thickeners;
0.001-0.5% of active compound;
15-70% of baked materials;
0.03-1% of preservatives;
optionally 1-6% of base;
optionally 4-20% of humectants;
optionally 0.03-1% of antioxidants;
optionally 0.003-0.1% of colours;
optionally 0.0007-0.015% of additives
and water as the remainder (in percent by weight).

Especially preferably, the gels according to the invention comprise (in percent by weight)
0.5-6% of thickeners;
0.0015-0.1% of active compound;
20-60% of bait materials;
0.05-0.5% of preservatives;
optionally 1.5-4% of base;
optionally 5-15% of humectants;
optionally 0.05-0.5% of antioxidants;
optionally 0.005-0.05% of colours;
optionally 0.0005-0.01% of additives
and water as the remainder (in percent by weight).

The viscosity of the gels according to the invention can be varied within wide limits and is generally 5,000-100,000 mPas. A preferred viscosity range is 8,000-60,000 mPas, an especially preferred viscosity range 10,000-50,000 mPas. The viscosity is measured using a rotational viscometer (from HAAKE) at a shearing rate of D=10 [1/sec], measured using a cone/plate system (4°). Owing to the heterogeneity of the gels, the readings vary. The viscosity can be adjusted by varying the nature and amount of the components, in particular of the thickener and of the bait material.

The water content of the gels according to the invention can be varied within a wide range and is generally between 10 and 80% by weight. A preferable content is 15-70% by weight, an especially preferred water content is 20-60% by weight.

The pH of the gels according to the invention can be varied within a wide range and is generally between pH 2 and pH 10. A preferred pH range is between pH 3 and pH 7, very especially preferably between pH 4 and pH 6.

(Harmful) rodents to be controlled are, for the purposes of the invention, those from the order Rodentia, with particular emphasis on the genera Rattus and Mus, Microtus, furthermore also Apodemus, Microtus, Arvicola and Clethrionomys, inter alia, with very particular emphasis on the representatives of the genera Rattus and Mus, for example R. rattus, R. norvegicus, M. musculus.

The gel according to the invention can be packaged in commercially available cartridges as are conventionally employed for packaging silicone. Application is then effected using the commercially available applicators. As an alternative, commercially available syringes, tubes and similar types of packaging are suitable for packaging and applying the gel according to the invention.

The bait can be applied in enclosed spaces and in the open, uncovered on all solid surfaces or else in bait containers.

The following properties distinguish the proposed bait system as unique and especially effective:
The bait material is highly attractive to rodents.
The bait retains this attraction even in a very humid and warm or dry environment.
The bait remains viscous, even after application, and adheres to the surface.
The bait can be packaged in applicators ready for use.
Neither packaging, applicator nor baited surface goes greasy or becomes stained.
The bait is ingested without particles being distributed in the environment.
The use of bait boxes can be dispensed with

Surprisingly, it is possible that such a gel can be prepared and stored in such a form that it is ready for use, i.e. without the necessity of several components having to be mixed prior to application. This is all the more surprising since foodstuffs are formulated, according to the invention, into an aqueous gel without the gel perishing owing to fungal or bacterial growth.

It is entirely surprising that even after storage and in the presence of high-quality alternative sources of food such as cereals and seeds, this bait is sufficiently attractive to harmful rodents such as house mice that infestation can be killed off in a comparatively short time span of a fortnight when using an anticoagulant active compound in the bait at the customary concentration.

It should be noted that the gel does not cure upon storage or after application and does not leave oil or water marks on the surface. It is entirely surprising that the bait remains soft as long as 10 months after application and adheres to the surface without any signs of deterioration.

The use of pigments for marking the bait as a rodenticide additionally prevents the staining of surfaces.

It must be noted in particular that the gel even retains its attraction to rodents when it is stored for prolonged period at high temperatures. Following 8 weeks' storage at 50° C., no loss in palatability and efficacy was discernible. It was unexpected that a bait stored in this manner is ingested readily in comparison with cracked wheat and that it, when given in conjunction with wheat for not longer than 4 days, 100% mortality results in wild house mice.

Surprisingly, the bait according to the invention also proved suitable for application to conduits (for example pipelines and cables) and dividing elements (for example dividing walls between pigsties) in animal houses without the use of bait boxes. Surprisingly, the bait did not desiccate even under high-ventilation conditions, continued to adhere and remained viscous. Even after several weeks, no changes in the bait were observed, despite the high microbial count in the air of the animal house.

The invention is illustrated by the examples which follow.

### PREPARATION EXAMPLES

Preparation Method 1

In a suitable reactor, the water thickener is stirred thoroughly together with the humectant. After a swelling time of approximately 15 minutes, water is added and the mixture is stirred for 10 minutes. Then, the bait material, the active compound, the preservative and the colour are added in succession with stirring, and stirring is continued for 15 minutes.

Preparation Method 2

Water is introduced into a suitable reactor, and the water thickener is sprinkled onto the water surface. After a swelling time of approximately 15 minutes, the mixture is stirred thoroughly, and the humectant and the preservative are subsequently added. To thicken the mixture, the stated amount of base is added dropwise with stirring. The bait material, the active compound and the colour are subsequently added in succession with stirring, and stirring is continued for 15 minutes.

The gels according to the invention which are listed in Table 1 below can be obtained by the methods stated above.

TABLE 1

| | Example 1 | Example 2 | Example 3 |
|---|---|---|---|
| | [% w/w] | [% w/w] | [% w/w] |
| Dispersant | Water | Water | Water |
| | 33.81 | 33.60 | 33.81 |
| Water thickener | Methylcellulose | Hydroxyethyl- | Carboxymethyl- |
| | 4.00 | cellulose | cellulose |
| | | 4.00 | 4.00 |
| Base for adjusting the | | | |
| pH | | | |
| Active compound* | Difethialone premix | Difethialone premix 0.125 | Difethialone premix |
| (Premix results in | 0.125 g/l | g/l | 0.125 g/l |
| 0.0025% difethialone | 2.08 | 2.08 | 2.08 |
| and 0.001% | | | |
| Denatonium | | | |
| benzoate) | | | |
| Bait material | Coarse oatmeal, | Soya fat, | Dry skimmed milk, |
| | 10.00 | 10.00 | 10.00 |
| | Glucose syrup | Beet sugar syrup | Glucose syrup |
| | 40.00 | 40.00 | 40.00 |
| Preservative | 1,2-Benzisothiazol- | Chloromethylisothiazoli- | 1,2-Benzisothiazol- |
| | 3(2H)-one (tradename | none/methylisothiazolin- | 3(2H)-one (tradename |
| | Proxel GXL) | one, 2-bromo-2- | Proxel GXL) |
| | 0.1 | nitropropane-1,3-diol | 0.1 |
| | | (tradename Preventol P | |
| | | 301) | |
| | | 0.30 | |
| Humectant | Sorbitol | Propylene glycol | Propylene glycol |
| | 10.00 | 10.00 | 10.00 |
| Colour | C.I. Pigment Blue 15 | C.I. Food Blue 2 | C.I. Pigment Green 7 |
| | (tradename Levanyl | 0.02 | (tradename Levanyl |
| | Blau BR-LF) | | Grün G-LF) |
| | 0.01 | | 0.01 |
| Bittering agent | Denatonium benzoate | Denatonium benzoate | Denatonium benzoate |
| | (see active compound) | (see active compound) | (see active compound) |
| Total | 100 | 100 | 100 |
| Preparation method | 1 | 1 | 1 |

| | Example 4 | Example 5 | Example 6 | Example 7 |
|---|---|---|---|---|
| | [% w/w] | [% w/w] | [% w/w] | [% w/w] |
| Dispersant | Water | Water | Water | Water |
| | 36.81 | 26.61 | 26.80 | 46.61 |
| Water thickener | Polyacrylic acid | Polyacrylic acid | Polyacrylic acid | Polyacrylic acid |
| | 1.00 | 1.00 | 1.00 | 1.00 |
| Base | 2 N sodium | 2 N sodium hydroxide | 2 N sodium | 2 N sodium |
| | hydroxide | 2.50 | hydroxide | hydroxide |
| | 2.50 | | 2.50 | 2.50 |
| Active | Difethialone | Difethialone premix | Difethialone | Difethialone |
| compound* | premix | 0.125 g/l | premix | premix |
| (Premix results | 0.125 g/l | 2.08 | 0.125 g/l | 0.125 g/l |
| in 0.0025% | 2.08 | | 2.08 | 2.08 |
| difethialone and | | | | |
| 0.001% | | | | |
| Denatonium | | | | |
| benzoate) | | | | |
| Bait material | Peanut butter, | Flaked coconut | Cacao butter, | Ground hazelnut |
| | 10.00 | 30.00 | 10.00 | 20.00 |
| | Maple syrup | Glucose syrup | Glucose syrup | Glucose syrup |
| | 40.00 | 30.00 | 50.00 | 20.00 |
| Preservative | 1,2- | Chloro- | 1,2- | Chloro- |
| | Benzisothiazol- | methylisothiazolinone/ | Benzisothiazol- | methylisothia- |
| | 3(2H)-one | methylisothiazolinone- | 3(2H)-one | zolinone/methyl- |
| | (tradename Proxel | 2-bromo-2- | (tradename | isothiazolinone, |
| | GXL) | nitropropane-1,3-diol | Proxel GXL) | 2-bromo-2-nitro- |
| | 0.1 | (tradename Preventol | 0.10 | propane-1,3-diol |
| | | P 301) | | (tradename |
| | | 0.30 | | Preventol P 301) |
| | | | | 0.30 |
| Humectant | Glycerol | Glycerol | Glycerol | Glycerol |
| | 7.50 | 7.50 | 7.50 | 7.50 |
| Colour | C.I. Pigment Blue | C.I. Pigment Green 7 | C.I. Food Blue 2 | C.1. Pigment |
| | 15 (tradename | (tradename Levanyl | 0.02 | Green 7 |
| | Levanyl | Grün G-LF) | | (tradename |
| | Blau BR-LF) | 0.01 | | Levanyl Grün G- |
| | 0.01 | | | LF) |
| | | | | 0.01 |
| Bittering agent | Denatonium | Denatonium benzoate | Denatonium | Denatonium |
| | benzoate | (see active compound) | benzoate | benzoate (see |
| | (see active | | (see active | active compound) |
| | compound) | | compound) | |
| Total | 100 | 100 | 100 | 100 |
| Preparation | 2 | 2 | 2 | 2 |
| method | | | | |

### Example of a Field Experiment

Amount of active compound: 0.0025% Difethialone in the bait
Packaging: 300 g PE cartridge, commercially available manual applicator
Formulation: see Ex. 5 in Table 1
Location: Feeding floor with cereals and seeds, zoo
Infestation with: Mus musculus
Bait stations: 10
Determination of the infestation: Flaked oats, uptake in 24 hours=281 g

Daily uptake of gel according to the invention in grams:

| | Day | | | | | | | | |
|---|---|---|---|---|---|---|---|---|---|
| | 1 | 2 | 3 | 4 | 5-7 | 8-10 | 11-14 | 15-19 | 20 |
| Up- | 133 | 117 | 232 | 133 | 220 | 103 | 76 | 51 | 2 |
| take | | | | | | | | | |
| (g) | | | | | | | | | |

Post-treatment check: Flaked oats, no uptake. The infestation had been eradicated after 20 days of treatment.

1. Composition comprising
(a) water as dispersant;
(b) thickener selected from the group of the organic and inorganic macromolecules;
(c) active compounds selected from the group of the stomach poisons;
(d) bait materials selected from the group of the vegetable and animal foodstuffs and feeding stuffs;
(e) preservative.

2. Composition according to claim 1 which, in addition to components (a) to
(e), additionally contains one or more of the following components
(f) base;
(g) humectants from the group of the polyols;
(h) antioxidants selected from the group butylhydroxytoluene, butylhydroxyanisole, tocopherols and ascorbic acid and their derivatives;
(i) colours selected from the group of the blue, red and green pigments and colorants;
(j) bittering agents
(k) additives.

3. Method for controlling harmful rodents, characterized in that compositions according to claim 1 or 2 are applied to the environment of harmful rodents.

4. Use of compositions according to claim 1 or 2 for controlling harmful rodents.

5. Device containing a rodenticide of the composition according to claim 1 or 2.
